(19) United States
(12) Patent Application Publication
(10) Pub. No.: US 2008/0180696 A1
(43) Pub. Date: Jul. 31, 2008

(54) Process window for EUV lithography

(75) Inventor: Minoru Sugawara, Delmar, NY (US)

Correspondence Address: MAYER & WILLIAMS PC, 251 NORTH AVE. WEST, 2ND FLOOR, WESTFIELD, NJ, 07090, US

(73) Assignees: Sony Corporation, Tokyo (JP); Sony Electronics Inc., Park Ridge, NJ (US)

(21) Appl. No.: 11/998,512

(22) Filed: Nov. 30, 2007

Related U.S. Application Data
(60) Provisional application No. 60/898,694, filed on Jan. 30, 2007.
(60) Provisional application No. 60/901,585, filed on Feb. 14, 2007.

(51) Int. Cl. G01B 11/14

(52) U.S. Cl. 356/624

(57) ABSTRACT

A method is provided for determining a process window for a lithography process using a reflective mask. The method begins by selecting a target Critical Dimension (CD) of a feature in an image pattern to be formed on a wafer and a corresponding CD tolerance. A CD of the feature formed on the wafer is determined as a function of exposure and focus position of light used in the lithography process. A shift in position of the image pattern is determined as a function of the exposure and the focus position. For the selected target CD and the selected corresponding CD tolerance, an Exposure-Defocus-Shift of pattern position (EDS).

### STATEMENT OF RELATED APPLICATIONS

This application claims the benefit of U.S. Provisional Patent Application Ser. No. 60/898,694, entitled “Assessment Of Pattern Position Shift For Defocusing In EUF Lithography”, filed Jan. 30, 2007.

This application also claims the benefit of U.S. Provisional Patent Application Ser. No. 60/901,585, entitled “Method of Producing Electric Devices”, filed Feb. 14, 2007.

Both of the prior applications are incorporated herein by reference in their entireties.

### BACKGROUND OF THE INVENTION

Semiconductor devices or integrated circuits (ICs) can include millions of devices such as transistors. For instance, ultra-large scale integrated (ULSI) circuits can include complementary metal oxide semiconductor (CMOS) field effect transistors (FET). Despite the ability of conventional systems and processes to fabricate millions of devices on an IC, because of technical and market pressures, there is still a need to decrease the size of IC device features, and, thus, increase the number of devices on an IC.

One limitation to achieving further reductions in the size of the critical dimensions of IC device features (e.g., linewidths, pitch) is conventional photolithography. In photolithography, a design is transferred onto a surface or wafer by shining a light through a mask (or reticle) of the design onto a photosensitive material (e.g., resist) covering the surface. The light exposes the photosensitive material in the pattern of the mask. A chemical process etches away either the exposed material or the unexposed material, depending on the particular process that is being used. Another chemical process etches into the wafer wherever the photosensitive material was removed. The result is the design itself, either imprinted into the wafer where the surface has been etched away, or protruding slightly from the wafer as a result of the surrounding material having been etched away.

The resolution limit of optical lithography can be expressed in terms of the Rayleigh equation:

W=K(λ/NA) (1)

where W is the resolution or minimum feature size that can be achieved, λ is the wavelength of the light used to form the image, NA is the numerical aperture of the projection system, and K is a constant that depends on the details of the imaging process.

The Rayleigh equation indicates that the achievable resolution can be reduced by decreasing the wavelength of light that is used to expose the resist. The light sources that have been used in lithography generate steadily decreasing wavelengths of light. For instance, the exposure wavelengths have decreased from the conventional g-line with a wavelength of 436 nm, to the i-line with a wavelength of 365 nm and a KrF excimer laser with a wavelength of 248 nm. More recently, an ArF excimer laser with a wavelength of 193 nm has been used. In addition, in order to achieve integrated circuits with linewidths less than 100 nm, other techniques are being developed such as a liquid immersion technique using an ArF excimer laser exposure system as well as a technique using an F₂ laser with a wavelength of 157 nm. But, even these techniques may not be sufficient to achieve linewidths less than about 70 nm.

Under these circumstances, a lithographic technique employing light having a wavelength of 13.5 nm, which falls in the so-called extreme ultraviolet light (EUV) spectral band, has attracted attention to print features with sizes of 50 nm and less. The image-forming principle of the EUV lithography is the same as in conventional photolithography to the extent that a mask pattern is transferred by means of an optical projection system. However, when EUV wavelengths are employed, a reflective mask needs to be used instead of the more commonly employed transparent mask. This is because there are no readily available materials that can transmit EUV wavelengths with a reasonable thickness.

When a reflective mask is used the light reflected from the front surface of the mask should be directed to the projection optical system without interfering with the light incident on the mask. This can only be achieved if the light incident on the reflective mask forms an oblique angle with the normal to mask surface. This angle depends on the numerical aperture NA of the lens of the projection optical system, the magnification of the mask, and the intensity of the light source. For example, when a mask having a magnification of 4 is disposed on a wafer and the exposing unit has an NA equal to 0.3, the light is incident on the mask with an incident angle greater than 4.30° with respect to the surface normal of the mask. Likewise, if the exposing unit has an NA equal to 0.25, the light is incident on the mask at an angle greater than 3.58°.

As is well known, lithographic techniques are often evaluated and characterized by a process window or process latitude. The process window defines the ranges of various parameters that will result in acceptable printing of a feature (e.g. a CD) within specified margins or tolerances. The most common process window parameters that are employed are focus and exposure. The acceptable range of focus is often referred to as the focus latitude or defocus. The acceptable range of exposure is often referred to as the exposure latitude. The exposure latitude and the focus latitude or defocus are often presented in a single plot referred to as an Exposure-Defocus (ED) window.

### SUMMARY OF THE INVENTION

In accordance with the present invention, a method is provided for determining a process window for a lithography process using a reflective mask. The method begins by selecting a target Critical Dimension (CD) of a feature in an image pattern to be formed on a wafer and a corresponding CD tolerance. A CD of the feature formed on the wafer is determined as a function of exposure and focus position of light used in the lithography process. A shift in position of the image pattern is determined as a function of the exposure and the focus position. For the selected target CD and the selected corresponding CD tolerance, an Exposure-Defocus-Shift of pattern position (EDS) process window is provided based on the CDs that have been determined.

In accordance with one aspect of the invention, providing the EDS process window includes obtaining an Exposure-Defocus (ED) window, an Exposure-Shift of pattern position (ES) window and a Defocus-Shift of pattern position (DS) window.

In accordance with another aspect of the invention, the determining steps are performed for both light incident on the reflective mask in a direction perpendicular to edges in a pattern disposed on the mask and light incident on the reflective mask in a direction parallel to the edges in the pattern disposed on the mask.

In accordance with another aspect of the invention, for incident light perpendicular to the pattern edges, a pattern shift bias is applied to the pattern disposed on the mask so that the CDs formed thereby are equal to the CDs formed by the light incident on the mask in a direction parallel to the edges in the pattern disposed on the mask when all other lithographic parameters are equal.

In accordance with another aspect of the invention, a process window is presented which illustrates a dependency of a mean value of the image pattern shifts on the focus latitude and the exposure latitude.

In accordance with another aspect of the invention, a process window is presented which illustrates a dependency of a range of the image pattern shifts on the focus latitude and the exposure latitude.

In accordance with another aspect of the invention, the light has a wavelength corresponding to a EUV spectral band.

### BRIEF DESCRIPTION OF THE DRAWINGS

FIG. 1 shows an example of a multilayer reflection mask used in EUV lithography.

FIG. 2 illustrates the manner in which EUV lithography is performed using a reflection mask such as the reflection mask shown in FIG. 1.

FIGS. 3a and 3b show a reflective mask and perpendicularly incident light and parallel incident light, respectively, incident upon and reflected from the mask.

FIG. 4 is a high level flowchart illustrating the steps performed to obtain a three dimensional process window that includes focus, exposure and pattern shift latitudes.

FIG. 5 shows an example of a successful compensation for achieving equivalent CDs between perpendicular and parallel incidences by adding a pattern shift bias of −12.5 nm for a target CD 44 nm and Ta thickness of 108 nm.

FIGS. 6a (perpendicular incidence) and 6b (parallel incidence) show CD-focus plots for a target CD of 44 nm and Ta thickness of 108 nm.

FIG. 7 shows an ED window for both perpendicular and parallel incidences using a CD tolerance of ±10% of the target CD.

FIG. 8 shows pattern position shift-focus curves for a single exposure.

FIG. 9a is an EDS window showing the dependency of the mean or average of the pattern shift on the focus latitude and FIG. 9b is an EDS window showing the dependency of the range of the pattern shift on the focus latitude.

FIG. 10a shows focus latitude results and FIG. 10b shows the range of the pattern position shift obtained from other EDS windows with CDs ranging from 44 to 22 nm and Ta thicknesses of 74 and 108 nm.

### DETAILED DESCRIPTION

In the case of EUV lithography, focus and exposure are not the only process parameters that significantly impact performance. This is because, as noted above, in EUV lithography the light incident upon the exposure mask forms an oblique angle with respect to the normal of the mask surface. The oblique angle of the incident light causes the position of the pattern formed on the wafer to be shifted in the direction of the incident light. This pattern shift can be characterized by defining another process window parameter that will be referred to hereinafter as the pattern shift latitude. Along, with the focus and exposure latitudes, it is often important to evaluate and characterize EUV lithographic techniques in terms of a three dimensional process window that includes focus, exposure and pattern shift latitudes.

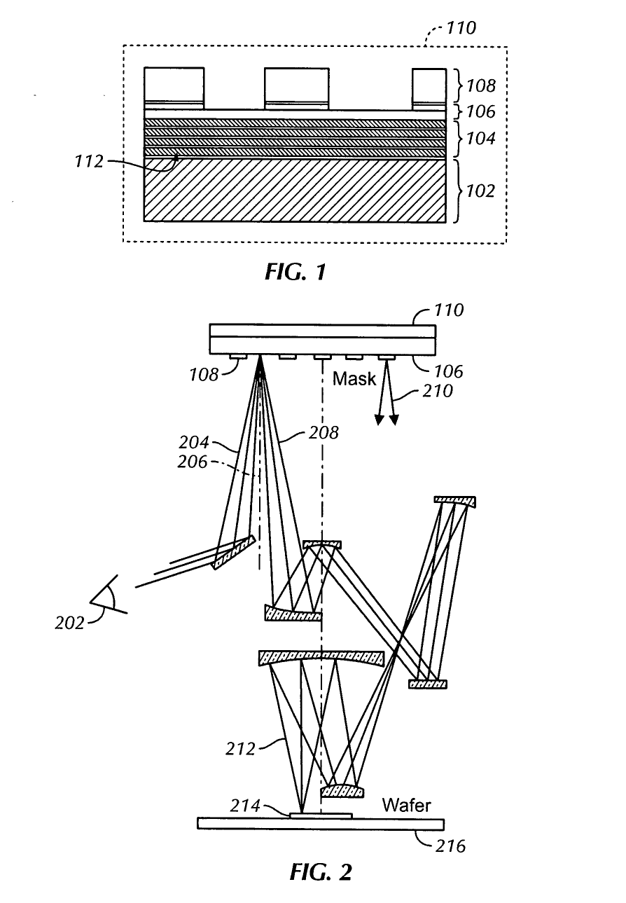

The EUV lithographic process will now be illustrated with reference to FIGS. 1 and 2. FIG. 1 shows an example of a multilayer reflection mask 110. The multilayer reflection mask 110 in FIG. 1 includes a silicon or glass substrate 102 and a reflective multilayer film 104 formed on the substrate 102. The reflective multilayer film 104 includes forty pairs of molybdenum and silicon, wherein the molybdenum layers are each about 3 nm thick and the silicon layers are each about 4 nm thick. A capping layer 106 including an amorphous silicon layer having a thickness of about 7 nm may be formed on the reflective multilayer film 104 to protect the reflective multilayer film 104 from oxidation. Alternative materials for capping layer 106 include Ru, Ti, and their oxides and compounds. Finally an absorbing layer 108 including a material such as Ta is formed on the capping layer 106.

FIG. 2 illustrates the manner in which EUV lithography is performed using a reflection mask such as the reflection mask 110 shown in FIG. 1. In FIG. 2 EUV light 204 emitted from an EUV source 202 is incident on the surface of the multilayer reflection mask 110 at an incident angle 206. The incident angle 206 denotes the angle between the incident direction of the light 204 and the surface parallel to the capping layer 106 or the absorbing layer 108. A portion of the incident light 204 is reflected with a relatively high reflectivity in a range of about 70% to about 80%, and the portion of the light 204 incident on the absorbing layer 108 is absorbed with high absorption of about 90% or more. Therefore, about 70% to about 80% of the light 204 is transferred into a relatively intense light beam 208 and about 10% or less of the incident light 204 is transferred into a less intense light beam 210. The reflected light 212, including the relatively intense light beam 208 and the less intense light beam 210, is transmitted onto a photoresist layer 214 disposed on the surface of the wafer 216. In this way the pattern on the surface of the multilayer reflection mask 110 is transferred to the surface of the wafer 216 by the relatively intense light beam 208.

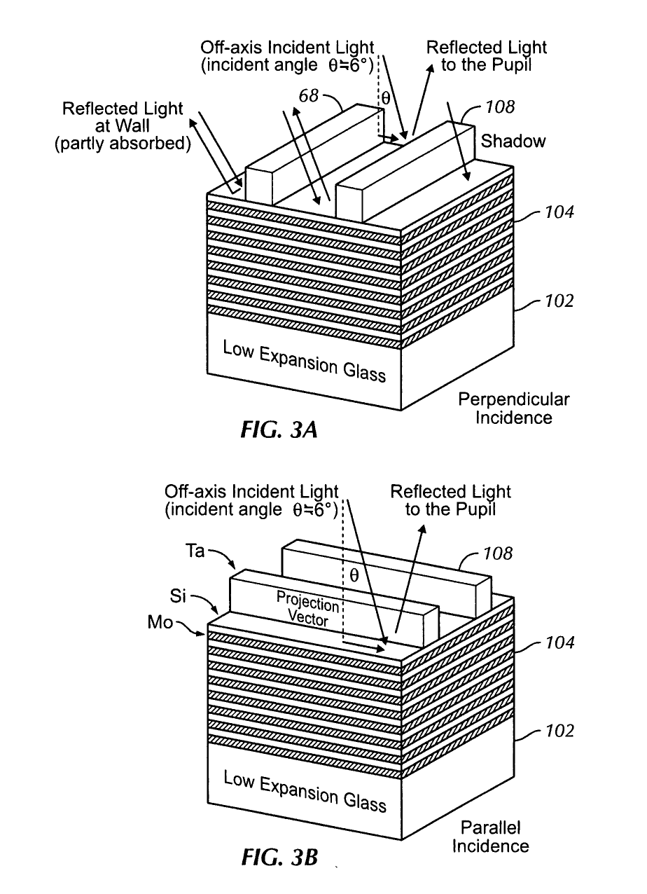

FIGS. 3a and 3b show a reflective mask and the light incident on and reflected from the mask. In FIG. 3a the light is incident onto the mask surface perpendicular to the edges of the absorber patterns 108. In FIG. 3b the light is incident onto the mask surface parallel to the edges of the absorber patterns 108. For perpendicular incidence, the projection vector of the incident light onto the mask surface is perpendicular to the edges of absorber patterns. For parallel incidence, the projection vector is parallel to edges of absorber patterns. It has been found that perpendicular incidence yields a pattern shift whereas parallel incidence does not yield a pattern shift. That is, parallel incidence yields the same printed pattern as normal incidence.

The method of developing a three dimensional process window that includes focus, exposure and pattern shift latitudes will be illustrated with a simulated example. The simulated conditions are shown in Table 1. Target CDs are 44, 33 and 22 nm. Pattern pitches with 8 levels are used for the target CD of 44 and 33 nm; 6 levels are used for the target CD of 22 nm. The pattern pitches in Table 1 cover dense to sparse layouts for infinitely long line-and-space patterns. For the target CD of 22 nm, dense pitches of 44 and 66 nm are omitted, because these pitches provide too little contrast to create aerial images. The wavelength of the exposure light is 13.5 nm and the mask magnification is 4×. The NA of the projection optics is 0.25. The CD tolerance is ±10%.

The mask absorber material is Ta which has reflective index of 0.9429-i0.0408. The alternative stack of Si and Mo with thicknesses of 4.2 and 2.8 nm and 40 bi-layers constitutes a mask substrate reflecting incident light in accordance with Bragg's law. The reflective indices of the Si and Mo layers are 0.9993-i0.0018 and 0.9211-i0.0064, respectively.

TABLE 1
Evaluation conditions

| | |
|---|---|
| Target CD (nm) | 44, 33, 22 |
| Pattern | Line and space |
| Pattern pitch (nm) | (CD 44 nm) 88, 110, 132, 154, 176, 214.5, 264, 297 |
| | (CD 33 nm) 66, 82.5, 99, 115.5, 132, 165, 198, 231 |
| | (CD 22 nm) 44, 55, 66, 77, 88, 110, 132, 154 |
| Optical conditons | Normal illuminatioan |
| | (NA 0.25/σ 0.90 for CD 44 nm and 33 nm) |
| | (NA 0.25/σ 0.80 for CD 22 nm) |
| | Annular (Outer σ 0.83/Innner σ 0.63) |
| | Dipole (σ 0.15 at the center of ±0.32 in the pupil) |
| Aberration | None |
| Mask | Absorber Ta (Thickness 74 nm and 108 nm) |
| | Reflective layer with Mo/Si 40 bi-layers |
| CD torelance | ±10% |

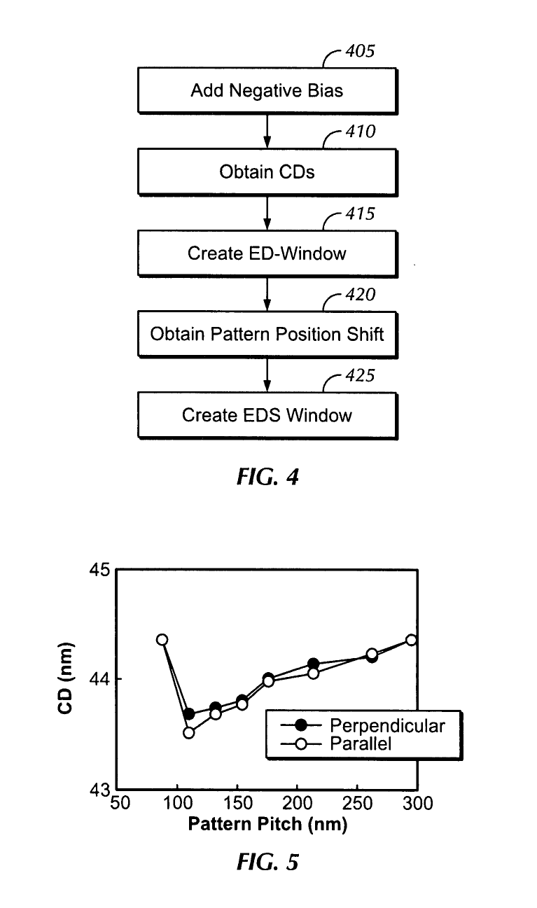

FIG. 4 is a high level flowchart illustrating the steps performed to obtain a three dimensional process window that includes focus, exposure and pattern shift latitudes. First, in step 405, before creating the process window, a negative pattern shift bias is added to the absorber patterns on the mask for perpendicular incidence so as to achieve the equivalent CDs between perpendicular and parallel incidences. Here the line patterns on the wafer are defined as the printed image beneath the absorber patterns on the mask. If no such bias were added, the CDs and contrast of the printed images for perpendicular incidence would be smaller than for parallel incidence. The average of the CDs across the pattern pitches listed in Table 1 is used for determining the amount of bias. The appropriate bias yields the same CD and contrast for both the perpendicular and parallel incidence. FIG. 5 shows an example of the successful compensation by adding a bias of −12.5 nm for a target CD 44 nm and Ta thickness of 108 nm.

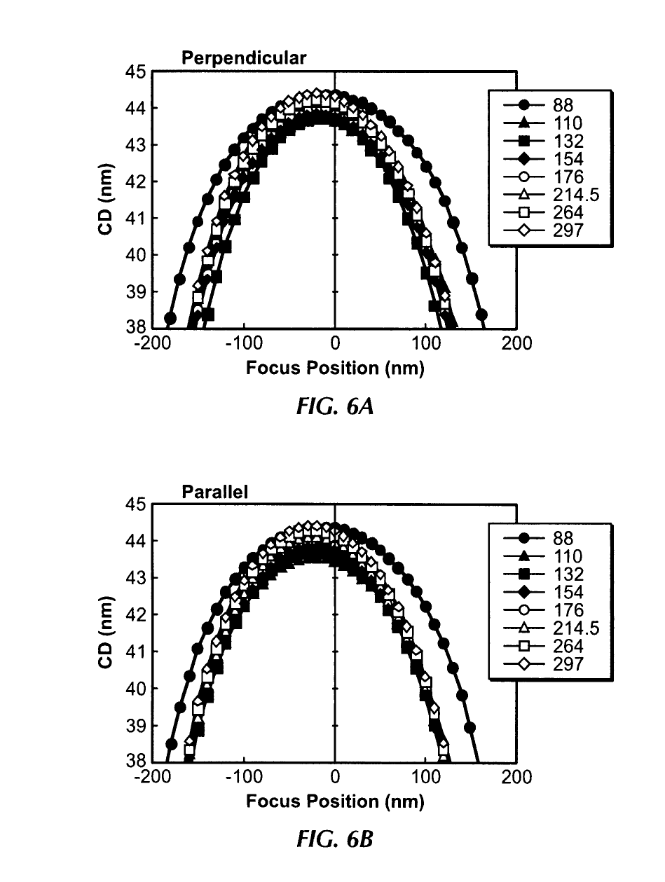

Next, in step 410 of FIG. 4 the CDs of the printed images on the wafer are obtained from CD-focus curves for perpendicular and parallel incidences. FIGS. 6a (perpendicular incidence) and 6b (parallel incidence) shows the plots for a target CD of 44 nm and Ta thickness of 108 nm. No significant difference appears in both plots. FIGS. 6a and 6b are shown for a single exposure. However, similar CD-focus curves are plotted for several exposure doses so that an ED window can be obtained.

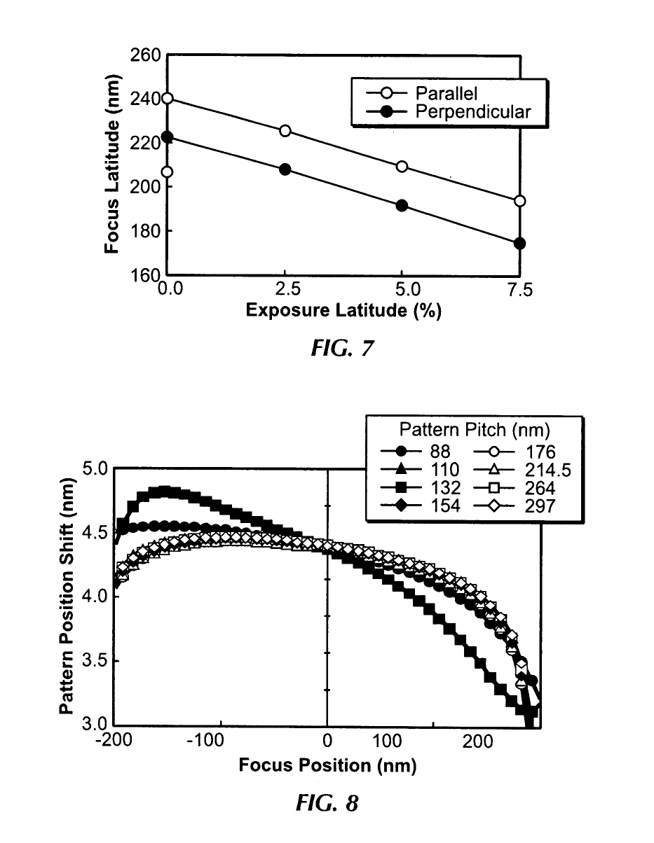

The CD-focus curves acquired in step 410 are used in step 415 to create the ED window, which is shown in FIG. 7 for both perpendicular and parallel incidences using a CD tolerance of ±10% of the target CD. As FIG. 7 indicates, perpendicular incidence dominates the size of the ED-window because its window is smaller in size than the window for parallel incidence. In particular, for a target CD of 44 nm, the focus latitude for perpendicular incidence is approximately 10% smaller than that for parallel incidence over an exposure latitude ranging from 0% to 7.5%.

Next, in step 420, the pattern position shift is determined for each data point measured in FIGS. 6a and 6b, which were used to obtain the ED-window of FIG. 7. FIG. 8 shows how the focus position influences the pattern position shift. It can be seen that the pattern position shift significantly depends on focus position, especially when the pattern pitch is in a semi-dense region. Similar to FIGS. 6a and 6b, FIG. 8 only shows curves for a single exposure. However, similar pattern position shift-focus curves are obtained for a range of exposures.

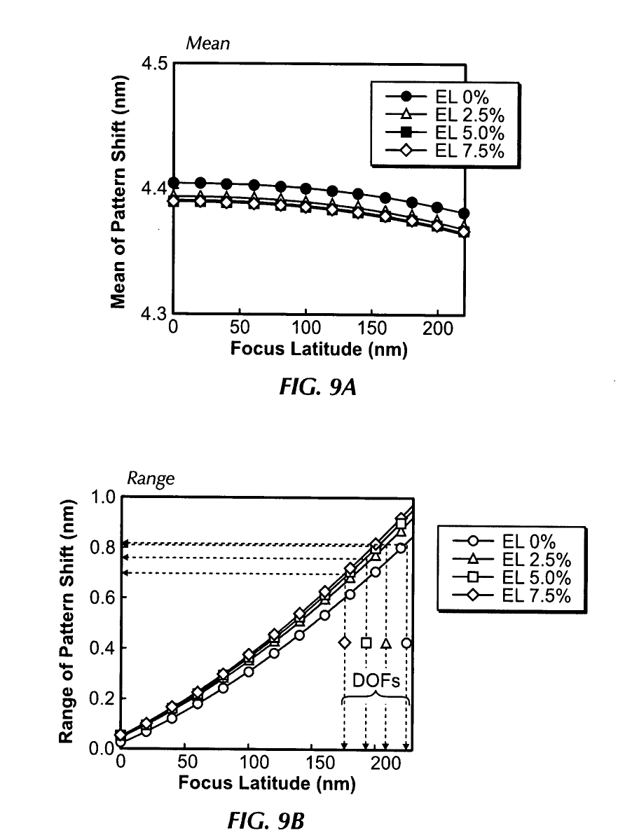

Finally, in step 425, the ED window obtained in step 415 is merged with the pattern position shift curves obtained in step 420 (one of which is shown in FIG. 8) in order to create an Exposure-Defocus-Shift of pattern position (EDS) window. The EDS window can be presented in a variety of different formats. For example, FIG. 9a shows the dependency of the mean or average of the pattern shift on the focus latitude. This dependency is shown for exposure latitudes of 0%, 2.5%, 5.0% and 7.5%. On the other hand, FIG. 9b shows the dependency of the range of the pattern shift on the focus latitude, also for exposure latitudes of 0%, 2.5%, 5.0% and 7.5%. The range of the pattern shift represents the difference between the maximum pattern shift and the minimum pattern shift.

In many cases the mean or average of the pattern shift such as shown in FIG. 9a is in practice less important than the range of pattern shift such as shown in FIG. 9b. This is because the mean value is correctable either by adding an offset to the exposure tool when printing the image or by uniformly shifting all the patterns across the mask. On the other hand, the range of the pattern shift is of significant importance because it gives rise to random errors in the pattern overlay because of defocusing. The range of the pattern shift in FIG. 9b indicates that the pattern shift is significantly influenced by the focus latitude in the ED-window. The exposure latitude has relatively little impact on the range of the pattern shift when the focus latitude remains constant. The three process latitudes representing the exposure dose (denoted EL), depth of focus (denoted DOF) and the range of pattern position shift—are summarized in Table 2. The Table indicates that when the exposure latitude (EL) becomes large, decreasing the DOF reduces the range of the pattern shift.

TABLE 2
Summary of exposure latitude (EL), depth of focus (DOF)
and tolerance of pattern position shift for target
CD of 44 nm and Ta thickness of 108 nm.

| EL (%) | DOF (nm) | Shift (range) (nm) |
|---|---|---|
| 0.0 | 223 | 0.81 |
| 2.5 | 208 | 0.82 |
| 5.0 | 192 | 0.76 |
| 7.5 | 175 | 0.70 |

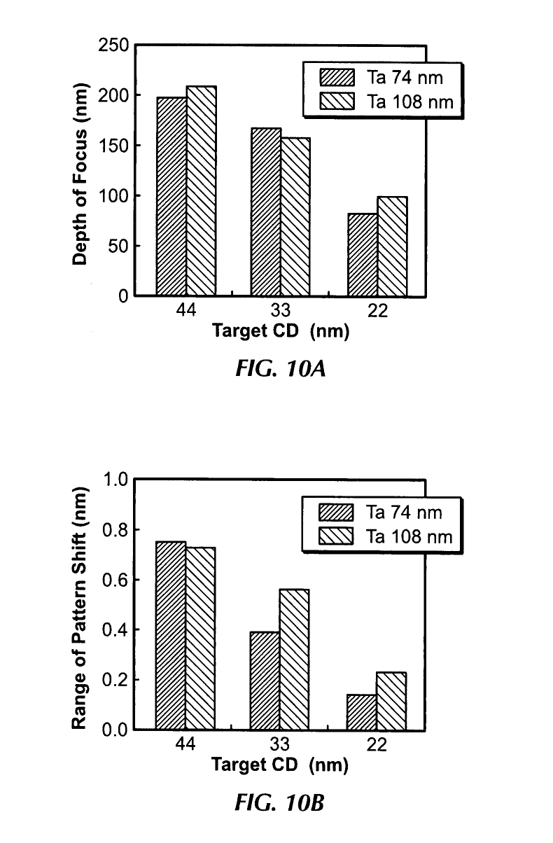

FIG. 10 shows results obtained from other EDS windows with CDs ranging from 44 to 22 nm and Ta thicknesses of 74 and 108 nm. In FIG. 10, the exposure latitude is assumed to be 5%. The focus latitude for the target CD of 22 nm decreases to half of that for a target CD of 44 nm, as shown in FIG. 10a. In FIG. 10b, the range of the pattern position shift decreases when the target CD becomes small. If the criterion for the range of the pattern position shift is selected to be within 10% of the overlay tolerance, which is the tolerance specified in ITRS (International Technology Roadmap for Semiconductors)2005 edition, then all the ranges that are plotted meet this criterion. Specifically, for the target CD of 44 nm the range is 0.8 nm, for the target CD of 33 nm the range is 0.6 nm and for the target CD of 22 nm the range is 0.4 nm. For the Ta thickness of 74 and 108 nm, no significant difference is observed for both the mean and the range of the pattern position shift.

1. A method of determining a process window for a lithography process using a reflective mask, comprising:
selecting a target CD of a feature in an image pattern to be formed on a wafer and a corresponding CD tolerance;
determining a CD of the feature formed on the wafer as a function of exposure and focus position of light used in the lithography process;
determining a shift in position of the image pattern as a function of the exposure and the focus position; and
for the selected target CD and the selected corresponding CD tolerance, providing an Exposure-Defocus-Shift of pattern position (EDS) process window based on the CDs that have been determined.

2. The method of claim 1 herein providing the EDS process window includes obtaining an Exposure-Defocus (ED) window, an Exposure-Shift of pattern position (ES) window and a Defocus-Shift of pattern position (DS) window.

3. The method of claim 1 wherein the determining steps are performed for both light incident on the reflective mask in a direction perpendicular to edges in a pattern disposed on the mask and light incident on the reflective mask in a direction parallel to the edges in the pattern disposed on the mask.

4. The method of claim 3 further comprising, for incident light perpendicular to the pattern edges, applying a pattern shift bias to the pattern disposed on the mask so that the CDs formed thereby are equal to the CDs formed by the light incident on the mask in a direction parallel to the edges in the pattern disposed on the mask when all other lithographic parameters are equal.

5. The method of claim 1 further comprising presenting a process window illustrating a dependency of a mean value of the image pattern shifts on the focus latitude and the exposure latitude.

6. The method of claim 1 further comprising presenting a process window illustrating a dependency of a range of the image pattern shifts on the focus latitude and the exposure latitude.

7. The method of claim 1 wherein the light has a wavelength corresponding to a EUV spectral band.

8. The method of claim 7 wherein the wavelength of the light is 13.5 nm.

9. The method of claim 1 further comprising repeating the determining and providing steps for a range of different pattern positions.

10. The method of claim 1 wherein the CDs and the image pattern shifts that are obtained are obtained in a simulation process.

11. A method of determining a process window for a lithography process using a reflective mask, comprising:
obtaining, for a range of different focus positions, a CD of an image pattern feature formed on a wafer by reflecting light off of a pattern disposed on a reflective mask;
obtaining, for a range of different exposures, the CD of the image pattern feature formed on the wafer;
obtaining a shift in position of the image pattern formed on the wafer relative to the pattern formed on the wafer over at least a portion of the range of different focus positions and different exposure doses; and
for a selected CD tolerance and pattern shift tolerance, determining exposure, focus, and pattern shift latitudes based on the obtained CDs of the image pattern.

12. The method of claim 11 wherein obtaining the exposure, focus, and pattern shift latitudes based on the obtained CDs of the image pattern includes obtaining an Exposure-Defocus (ED) window before obtaining the shifts in the image pattern position.

13. The method of claim 11 wherein the obtaining steps are performed for both light incident on the mask in a direction perpendicular to edges in the pattern disposed on the mask and light incident on the mask in a direction parallel to the edges in the pattern disposed on the mask.

14. The method of claim 11 further comprising, for incident light perpendicular to the pattern edges, applying a pattern shift bias to the pattern disposed on the mask so that the CDs formed thereby are equal to the CDs formed by the light incident on the mask in a direction parallel to the edges in the pattern disposed on the mask when all other lithographic parameters are equal.

15. The method of claim 11 further comprising presenting a process window illustrating a dependency of a mean value of the image pattern shifts on the focus latitude and the exposure latitude.

16. The method of claim 11 further comprising presenting a process window illustrating a dependency of a range of the image pattern shifts on the focus latitude and the exposure latitude.

17. The method of claim 11 wherein the light has a wavelength corresponding to a EUV spectral band.

18. The method of claim 17 wherein the wavelength of the light is 13.5 nm.

19. The method of claim 11 further comprising repeating the obtaining and determining steps for a range of different pattern positions.

20. The method of claim 11 wherein the CDs and the image pattern shifts that are obtained are obtained in a simulation process.
